(19) United States
(12) Patent Application Publication
(10) Pub. No.: US 2007/0026825 A1
(43) Pub. Date: Feb. 1, 2007

(54) NFC device and apparatus

(75) Inventor: Robin Wilson, Cirencester (GB)

Correspondence Address: Brian P. Hopkins;Mintz Levin Cohn Ferris Glovsky and Popeo PC, 666 Third Avenue, New York, NY, 10017, US

(73) Assignee: Innovision Research & Technology Plc, Wokingham (GB)

(21) Appl. No.: 11/362,288

(22) Filed: Feb. 24, 2006

(30) Foreign Application Priority Data
Feb. 24, 2005 (GB) GB 0503847.6
Aug. 16, 2005 (GB) GB 0516796.0

(51) Int. Cl. G06F 3/033

(52) U.S. Cl. 455/130

(57) ABSTRACT

An NFC device comprises a modulationdepth detector (114) capable of detecting a plurality of different modulation depths, said detector responsive to receipt of a signal (105, 106) by said NFC device to determine which modulation depth of said plurality of different modulation depths has been used to modulate said signal received by said NFC device and generate a signal (117) for transmission to a controller (100) that indicates the modulation depth of said received signal, said controller (100) being configured on receipt of said signal from said detector (114) to select for demodulation of subsequent signals received by said NFC system a demodulator (115, 116) that is capable of demodulating signals of the modulation depth detected by said detector (114). The controller (100) may form a part of the NFC device itself or be a part of host apparatus in which the NFC device is located.

### RELATED APPLICATIONS

This application claims priority to United Kingdom patent application nos. GB0503847.6, filed Feb. 24, 2005, and GB0516796.0, filed Aug. 16, 2005, each disclosure of which is herein incorporated by reference in its entirety.

### FIELD OF THE INVENTION

This invention relates to a near field communications (NFC) device and apparatus comprising such an NFC device. An embodiment of the invention relates to a detector, for use in such a device, that is configured to detect which of two or more differently modulated signals has been received by the NFC device.

### BACKGROUND TO THE INVENTION

Wireless non-contact communication systems have previously been proposed.

One such system is generally known as a near field RFID (Radio Frequency Identification) system, and employs a near field RFID tag and a near field RFID reader for reading information stored on the tag by means of magnetic field (H-field) inductive coupling between the reader and the tag. Near field RFID tags are referred to below as tags. Near field RFID readers are referred to below as readers. Readers and tags are together referred to below as RFID devices.

Such tags typically include an antenna, a controller and a memory (which may be part of the controller) in which information (for example information about the article to which the tag has been attached, control data or program data) is stored or may be stored.

For so-called passive tags, a compatible reader uses a radio frequency (RF) signal (for example a signal at 13.56 MHz) to generate a magnetic field and when the antenna of the tag is in close proximity to the reader the magnetic field (H-field) generated by the reader is inductively coupled from the reader to the tag resulting in derivation and supply of power to the controller. Supply of power enables operation of the tag, for example enabling the tag controller to operate and access the memory and transmit information from the memory via the tag antenna to the reader. Transmission of information from the memory will be through modulation of the supplied magnetic field (H field). In this context a compatible reader is a reader operating at the same radio frequency as the tag and in accordance with the same communication protocols.

RFID readers typically include an antenna, controller, memory (which may form part of the controller), signal generator, modulator (for modulating a generated RF signal with data from either the controller and/or memory) and demodulator (for demodulating a modulated RF signal received from for example a tag.

Illustrative RFID devices are described in various international standards, for example ISO/IEC 14443 and ISO/IEC 15693.

In addition to RFID devices of the types described above, it has also previously been proposed to provide so-called Near Field Communications (NFC) devices.

NFC devices, often referred to as NFC communicators (which two terms may be used interchangeably), are radio frequency non-contact communications devices that can communicate wirelessly with other NFC devices and/or RFID devices over relatively short ranges (for example a range in the order of several centimetres up to a maximum range of in the order of a metre or so). Communication is via inductive coupling of a magnetic field (H field) between the NFC device and a second NFC device or RFID device.

Illustrative NFC devices and systems are described in ISO 18092 and ISO 21481, and the operation of NFC devices depends on whether they are operating as an “initiator” or a “target”, and whether they are operating in a “passive communications mode” or an “active communications mode”. As will be apparent from the following, the terms “passive” and “active” in the context of NFC devices do not have the same meaning as “passive” and “active” when used in the context of traditional RFID devices.

An initiator NFC device will generate an RF field and start communication. A target device will respond to receipt of an RF field from an Initiator NFC device. Response will be through modulation of the supplied RF field or through generation of a new RF signal and modulation of that RF signal.

In a “passive communications mode” the Initiator NFC Device will generate an RF field and the Target NFC device will respond to an Initiator command by modulation of the received RF signal, usually by load modulation. In an “active communications mode both the Initiator NFC device and the Target NFC Device use their own RF field to enable communication.

It will be apparent from the foregoing that a first NFC device can operate in a passive mode (in a manner akin to a conventional RFID tag) and use an RF field generated by a conventional RFID reader or a second NFC device to respond to that reader or second NFC device. Alternatively, the first NFC device can operate in an active mode to generate an RF field for interrogating a conventional RFID tag or for communication with a second NFC device that may be operating in a passive or an active mode (i.e. either by using the RF field generated by the first device to communicate with the first device or by generating its own RF field for communication with the first device).

This allows such NFC devices to communicate with other NFC devices, to communicate with RFID tags and to be ‘read’ by RFID readers.

NFC devices may be in stand-alone form (either hand-held or free-standing) or comprised within a system (either in stand-alone form or by being integrated within the system), for example a mobile transceiver (such as a mobile telephone or cellphone), a personal digital assistant (PDA), IPOD®, portable music players, an item of computer equipment such as a personal or portable computer, or a vending machine. NFC devices can be implemented by means of a single integrated circuit (a so-called one-chip solution or system on chip) and/or optionally by means of separate functional component parts or separate integrated circuits.

NFC devices are programmed and designed in accordance with a particular communication protocol or series of protocols in mind. NFC devices are only able to communicate with other NFC devices or RFID devices operating to the same or a compatible protocol or series of protocols.

NFC devices as part of their normal functionality are required to respond to a variety of different communications protocols (such protocols being dependent for example on the mode of operation or RFID/NFC device with which the NFC device is communicating). In particular, the emerging NFC protocols (set out in ISO 21481 and ISO 18092 for example) require amongst other modulation types amplitude modulation to be used in two distinct communications protocols:—a first that uses a shallow modulation depth of nominally 10%; and a second that uses a deep modulation depth of 100%.

It would be advantageous, from a manufacturing cost point of view, to construct a system that can handle both signal protocols, and an apparently attractive approach would be to provide a single demodulator through which signals of any modulation type could be passed. Such a solution is particularly attractive as it would not require additional circuitry that would otherwise increase the substrate, for example silicon, footprint of the circuitry (if embodied as an integrated circuit), and much of this attraction arises because of the fact that in an integrated circuit the cost of the substrate material, e.g. silicon, represents a relatively large proportion of the cost of the overall device.

However, one factor that has hitherto been unrecognised is that as a demodulator which can demodulate a signal having a shallow modulation depth is relatively power-hungry, the incorporation of an NFC device that includes only such a shallow modulator into a power-sensitive system (for example a device such as a mobile telephone that relies on a battery for power), adversely affects the operation of that system—for example by reducing the time between charges of the battery. In systems such as mobile telephones where the battery life of the telephone is often an important commercial feature (at least in the eyes of the prospective purchaser of that telephone), a reduced battery life is unattractive and hence highly undesirable.

An object of the present invention is to provide an NFC device that alleviates the aforementioned problems. An ancillary aim of the present invention is to provide an NFC device that enables the detection of the particular modulation depth of a received signal, and which configures the device in response to such detection to use a demodulator that is appropriate for the particular modulation depth detected.

### SUMMARY OF THE INVENTION

To this end, viewed from one aspect the present invention provides an NFC device comprising a modulation-depth detector operable to detect a plurality of different modulation depths, said detector responsive to receipt of a signal by said NFC device to generate a depth signal for transmission to a controller for said NFC device indicative of the modulation depth of said received signal.

Advantageously, with the device of this preferred embodiment when an NFC system in target mode receives an RF signal from an NFC device in initiator mode or an RFID reader, the target NFC device can quickly, automatically and reliably detect which modulation type (protocol) the received signal is using.

In particular the controller is configured to select for demodulation of subsequent signals received by said NFC system a demodulator that is capable of demodulating signals of the modulation type detected by said detector responsive to receipt of said depth signal from said detector. Thus, the quick, automatic detection of received signal protocol enables the target device to rapidly change operation to correctly receive and respond to incoming signals, and enables power control in the system—in particular by providing that relatively power-hungry components are only used when it is necessary to do so.

In one embodiment said controller and said detector form part of the same NFC device. In another embodiment the controller forms part of a host apparatus. That host apparatus may be selected from the group consisting of for example a mobile or cellular telephone, a portable digital assistant, an IPOD®, a portable music player, a vending machine and a portable computer.

In a preferred arrangement the device comprises a plurality of demodulators each configured to demodulate received signals of a particular modulation depth and generate a demodulated output signal. In this embodiment the detector is preferably arranged to receive the demodulated output signals from said demodulators and a plurality of reference signals, compare respective received demodulated signals with associated reference signals, and output a match signal indicating which of said received signals at least substantially matches the reference signal with which it has been compared.

Preferably the detector is configured on receipt of a signal by said NFC device to determine which one modulation type of said plurality of different modulation types has been used to modulate said signal received by said NFC device. In this arrangement it is preferred that the controller is configured responsive to said signal from said detector to select for demodulation of subsequent signals received by said NFC device only the demodulator that is capable of demodulating signals of the one modulation type detected by said detector.

The detector may comprise a first data recogniser configured to detect a first modulation depth, and a second data recogniser configured to detect a second modulation depth different from said first depth. Suitably, the first modulation depth is a deep modulation depth and said second modulation depth is a shallow modulation depth.

Generally speaking, the first modulation depth is a deep modulation depth of nominally 100% and said second modulation depth is a shallow modulation depth of nominally 10%.

Preferably the shallow demodulator comprises a peak detector, a sample and hold circuit, and a processor. The processor may comprise an analogue to digital converter and a digital signal processor.

In accordance with another embodiment of the present invention, there is provided a modulation-type detector for use in an NFC device, the detector comprising a data recogniser configured to receive a plurality of demodulated signals each of which have been derived from a single received signal of unknown modulation and a plurality of associated reference signals, said data recogniser being operable to compare said received demodulated signals with respective reference signals and output a match signal indicating which of said received demodulated signals at least substantially matches the reference signal with which it has been compared.

In this embodiment the demodulated signals may be generated by demodulating said single received signal of unknown modulation with a plurality of demodulators that are each configured to demodulate signals having a particular modulation type.

Another embodiment of the present invention relates to a method of operating an NFC device, the method comprising: providing a controller; a plurality of demodulators each of which is capable of demodulating received signals of a different modulation type and outputting a demodulated signal; and a detector arranged to receive the demodulated signals from said demodulators and a plurality of reference signals, compare respective received demodulated signals with associated reference signals, and output a match signal indicating which of said received signals at least substantially matches the reference signal with which it has been compared; receiving a signal of unknown modulation type to initiate a communications session; demodulating said unknown signal using said plurality of demodulators to generate a plurality of demodulated signals; comparing said plurality of demodulated signals with their associated reference signals; outputting to said controller a signal indicating which of said demodulators has generated a demodulated signal that at least substantially matches the associated reference signal, and controlling the system to demodulate received signals for a remainder of said session using only that demodulator which has been indicated by said detector as generating a signal which at least substantially matches the associated reference signal.

In another embodiment, an NFC device is described which comprises detection means operable to detect which of two or more differently modulated signals has been received by the NFC device. In a particularly preferred embodiment such signals are 10% amplitude modulated and 100% amplitude modulated.

A further embodiment provides an NFC device comprising a detector that is configured to respond to receipt of a modulated signal to determine which of two or more different modulation types have been used to modulate said received signal and output a signal indicating the modulation of said received signal, and a controller for interpreting the signal received from the detector. In a particularly preferred embodiment the controller is responsible for controlling operation of the NFC device and in particular is responsible for generating a response signal with a modulation that is appropriate for the particular type of modulated signal that has been received and detected.

In a further embodiment of the invention there is provided an NFC device that comprises a modulation-type detector that is operable responsive to receipt of a modulated signal to determine the depth of modulation of said received signal, said modulation-depth detector comprising a deep detector for detecting a first signal modulation depth and a shallow detector for detecting a second signal modulation depth. In a particularly preferred embodiment the deep detector may be a gap detector and the shallow detector may comprise a demodulator. It should be herein noted that the gap detector may be regarded as a form of demodulator.

### BRIEF DESCRIPTION OF THE DRAWINGS

Various presently preferred embodiments of the present invention will now be described, by way of example, with reference to the accompanying drawings, in which:

FIG. 1 is a schematic circuit diagram of an NFC device;

FIG. 2 is a schematic representation of illustrative functional elements of a detector of such an NFC device;

FIG. 3 is a schematic representation of one signal modulation depth and an associated detector;

FIG. 4 is a schematic representation of another modulation depth;

FIG. 5a is a schematic representation of a detector for the modulation depth depicted in FIG. 4;

FIG. 5b is a schematic representation of another detector for the modulation depth depicted in FIG. 4;

FIG. 6 is a schematic circuit diagram for a component of either of the detectors illustrated in FIG. 5a or 5b;

FIG. 7 is a schematic representation of the signal waveforms at the input and output of the component depicted in FIG. 6;

FIG. 8 is a schematic circuit diagram illustrating a particularly preferred implementation of the component depicted in FIG. 6;

FIG. 9 is a schematic representation of signal waveforms relating to a component of the detector of FIG. 5a and FIG. 5b;

FIG. 10 is a schematic representation of the manner in which a component of the detector of FIG. 5 operates;

FIG. 11 is a schematic representation of an NFC device; and

FIG. 12 is a schematic representation of a cellular telephone in accordance with an embodiment of the present invention.

### DETAILED DESCRIPTION OF THE EMBODIMENTS

Prior to embarking upon a detailed description of embodiments of the invention, it is worth noting at this juncture that the present teachings may be embodied in a device that comprises NFC device functionality, but not necessarily a device comprising all the functionality of an NFC device. Furthermore, embodiments of the present invention may be implemented in a dedicated device in standalone form (either hand-held or free-standing) or comprised within a larger device/apparatus or host device that comprises other functionality, for example a mobile communications device (such as a mobile telephone or cell phone), a so-called personal digital assistant (PDA), an IPOD®, a personal computer, portable music player, a laptop computing device, a game console or a vending machine.

It is also the case that the present teachings may be implemented by means of a single integrated circuit or in an optional arrangement by component parts of separate integrated circuits. In embodiments where the NFC device is integrated within a larger host device or apparatus, functions may be shared between the NFC device and the larger device or host apparatus, for example the NFC device may not have its own memory and may instead use memory provided within the larger device or host apparatus.

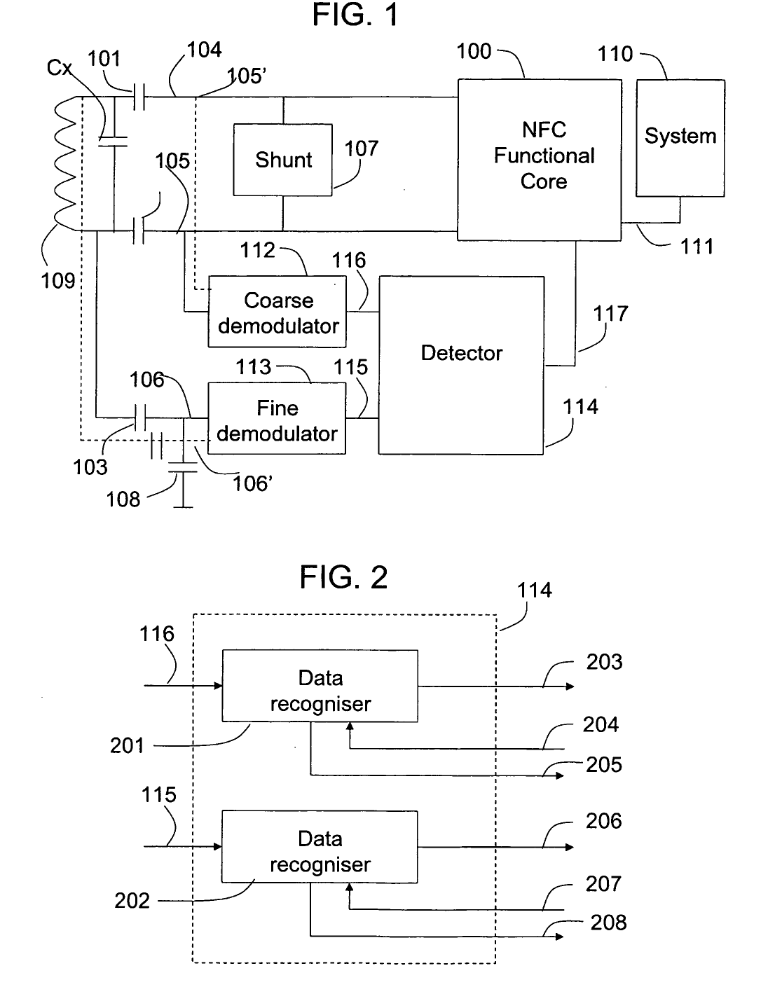

FIG. 1, as mentioned above, is a schematic representation of an NFC device 1 according to a preferred embodiment of the present invention. The NFC device 1 comprises an NFC functional core 100 that includes all the functionality required for operation of the NFC device. For example the functional core 100 may include a microprocessor or microcontroller for controlling the operation of the NFC device (hereafter referred to as “a controller”), a signal generator for generating an RF signal, a modulator for modulating the RF signal, a clock signal generator for providing a clock signal for the functional core, and data storage means for storing data. As mentioned previously, the various parts of the NFC device may be provided by one circuit, a number of circuits or integrated with a host system or apparatus, which terms are herein used interchangeably. For example, control of the NFC device may be accomplished by a host apparatus processor in which case either the NFC device can be controlled directly by such host apparatus processor or in the alternative an interface processor (for example a RISC processor) may interface between the host apparatus processor and the NFC device.

In this embodiment the functional core 100 is coupled to additional system components (generally referenced by box 110) by an appropriate connector 111. The system components, if provided, may comprise a host system processor, a sensor, an actuator, or any other device that is capable of interacting with the NFC device's local environment.

In the particular arrangement illustrated in FIG. 1, and includes a tuned circuit (consisting of capacitors 101 and 102, and an inductive coupler 109 (in this instance a coil)) for receiving an incoming RF signal—for example from an RFID reader or other NFC device. Further capacitors may also be included as required, for example Cx as shown in FIG. 1. As an alternative to a series tuned circuit, the NFC device may alternatively comprise a parallel tuned circuit (where the capacitor(s) are in parallel with the inductive coupler), when the shunt presents a low impedance.

In operation an RFID reader or an NFC device in initiator-mode transmits a modulated RF signal, and this signal is received by the NFC device 1 via the inductive coupler 109.

In the preferred arrangement a shunt regulator 107 is provided, and functions to constrain voltages induced between circuit nodes 104 and 105 to a level that avoids damage to device circuitry.

In this embodiment the NFC device 1 is configured to receive two types of modulated RF signal: a first signal that is amplitude modulated to a depth of 100%, and a second signal that is amplitude modulated to a depth of 10%. A coarse or deep demodulator 112, for example a gap detector, is provided for demodulation of the 100% modulated RF signal; and a fine or shallow demodulator, comprising for example a demodulator 113, is provided for demodulation of the 10% modulated RF signal. The terms shallow and deep shall be used hereinafter.

The deep-demodulator 112 is specifically designed for the demodulation of large modulation depths, and will not work accurately, reliably or possibly at all for small demodulation levels such as a 10% modulation depth. Similarly, the shallow-demodulator 113 is specifically designed for demodulating small modulation levels, and as such may be less accurate and reliable for large demodulation levels. The difference in operation between the two demodulators can be used to detect the modulation type of signal received.

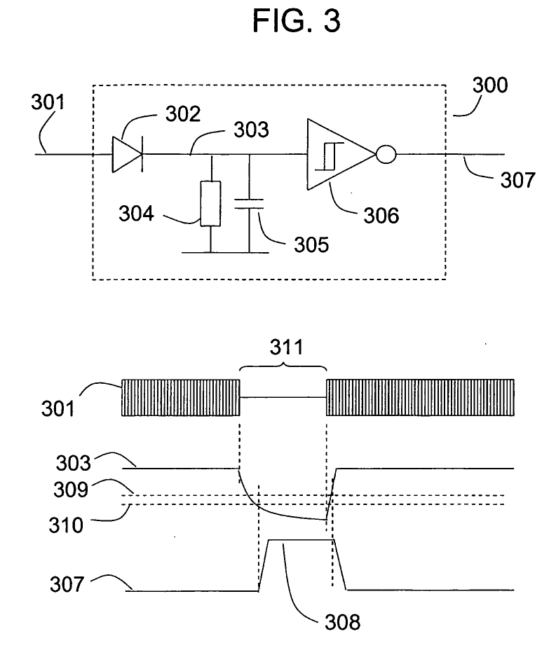

Whilst it will be apparent persons skilled in the art that different forms of deep and shallow demodulators may be used, in a preferred embodiment the deep demodulator may comprise a gap detector which detects the absence of the RF signal during the gaps caused by the 100% modulation. An illustrative example of one such device is shown in more detail in FIG. 3.

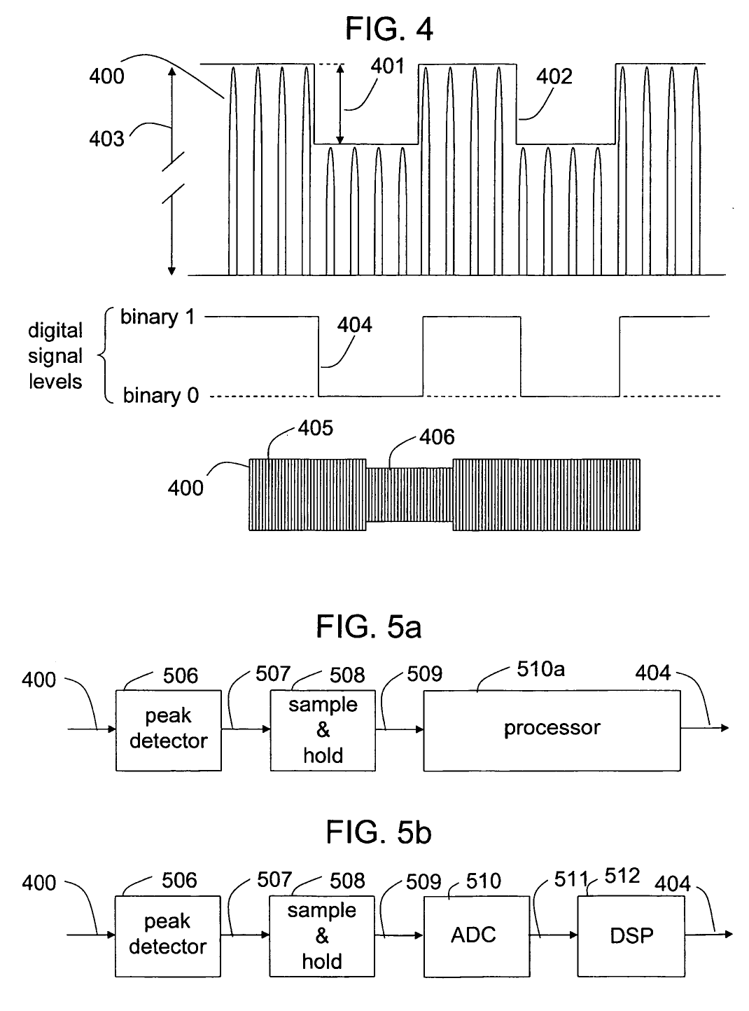

An illustrative example of a shallow demodulator is depicted in FIGS. 4 to 10, and comprises (as will later be described in detail) a peak detector that receives an induced RF signal, a sample and hold circuit that derives an analogue envelope signal from the output of the peak detector, and a processor that derives a digital demodulation signal by converting the analogue envelope signal into a digital representation of the same signal. Optionally, an I & Q demodulator may be used as the shallow demodulator. One advantage of using an I&Q demodulator is where the NFC device is also configured to receive phase modulated signals.

Referring to FIG. 1, output signals 115 and 116 from the shallow demodulator 113 and deep-demodulator 112, respectively, go to a detector 114 and output signals 117 from the detector 114 are fed to the NFC functional core 100. As will later be described in detail, the detector 114 is configured to analyse signals 115 and 116 and determine whether one and/or the other is supplying a recognisable signal. If the one and/or the other supplied signals are recognisable the detector 114 is configured to signal, or control, the NFC functional core 100 according to the modulation depth of the received signal(s). In a preferred arrangement, the detector comprises a microcontroller, a microprocessor, a RISC processor, logic or a state machine. Signals 117 include control signals between the NFC functional core 100 and the detector 114, and such control signals may be used to exchange status information and change detection parameters. Whilst the detector is depicted as being separate from the NFC functional core 100, it will be apparent that the detector 114 may be provided within the NFC functional core 100 or indeed within the system components 110.

Referring now to FIG. 2, in a preferred embodiment the detector 114 comprises a first data recogniser 201 and a second data recogniser 202. Data recogniser 201 may be configured to output a data match signal 203 when one or more sequence of pulses input on signal 116 match, or at least substantially match, one or more predefined patterns. Such predefined patterns may be of the following different types (or any of many other types): pulse-count, bit-level, or word-level.

For a pulse-count pattern, the recogniser will output a match signal if one or more pulses arrive within a predetermined time period. For a bit-level pattern the recogniser will output a match signal if a predetermined bit-coding protocol is matched for one or more bits, preferably for two or more bits. For a word-level pattern the recogniser will output a match signal if a predetermined data word coding protocol for one or more data words is matched. In one implementation a match signal may be output if an incoming data word matches the predetermined coding protocol irrespective of the actual data contained within the word. Alternatively, the data recogniser may be configured to match incoming data words where the data within the words is also predetermined.

Similarly, data recogniser 202 may be configured to output a data match signal 206 when one or more sequence of pulses input on signal 115 match, or at least substantially match, one or more predefined pattern types (for example, any of those described above). Data recogniser 202 may also be configured to match a different type of predefined pattern to the type of predefined pattern that data recogniser 201 is configured to match.

Data recogniser 201 is configured to receive signals 204 from the NFC functional core 100 that convey status or control information, and to communicate status or control information to the functional core 100 by means of signals 205. In a similar manner data recogniser 202 is arranged to receive or communicate information to or from the functional core 100 by way of signals 207 and 208 respectively. Such signals may be used for example to alter or adjust data recogniser parameters, to control functional actions of the functional core 100 or to control functional actions of system components 110. Signals 203 to 208 are collectively represented by signal 117 in FIG. 1.

Referring again to FIG. 1, whilst the deep-demodulator 112 is shown as being coupled to circuit node 105, it will be appreciated that this is only one possibility. The deep demodulator could alternatively be connected to circuit node 106. Alternatively the deep demodulator may be connected at both 105 and 105′ (shown by dotted lines in FIG. 1). Similarly, whilst the shallow-demodulator 113 is depicted as being connected to circuit node 106, it could alternatively be connected to circuit node 105 or to both circuit node 106 and 106′ (shown by dotted lines in FIG. 1). In general terms, device requirements and circuit configuration requirements will dictate whether all of RF signal receiving components 101, 102, 103, 108, Cx and 109 are required, which deep-demodulator 112 and shallow-demodulator 113 connections are used, and if additional or alternative components are required.

Once the modulation depth of the received signal has been detected by the detector block and a signal sent to the functional core to notify the depth detected, the functional core responds in accordance with its stored data and the instructions contained within its own controller (which controller, as has been mentioned above, may be comprised within the NFC device or separately). For example the NFC functional core may be configured to respond in one particular way on receipt of a 10% amplitude modulated signal and in a different way on receipt of a 100% modulated signal, and that NFC functional core response may comprise the generation of a modulated RF signal or alternatively a further modulation of the received RF signal. The NFC device may also be configured such that the detection of different signal modulation depths has a functional effect on the operation of a larger device or system of which the NFC forms part or is connected to. As an illustrative example, receipt of a particular modulation depth may cause the larger device or system to be activated or de-activated.

Referring now to FIG. 3, there is depicted an illustrative circuit and associated signal waveform of a gap detector 300 that may be used as a deep demodulator 112 in FIG. 1. In this arrangement, an input signal 301 (which represents a 100% modulated signal received at circuit node 105) is fed to a diode 302 and illustrative waveform of the input signal is shown with shaded boxes representing continuous carrier and a carrier gap 311 being equivalent to a period of 100% modulation. The diode 302 outputs a signal 303 that is smoothed by capacitor 305 and this smoothing is reflected in the waveform by the decay that occurs from the beginning of the carrier gap 311. The decay rate is proportional to the ratio of the value of capacitor 305 to the value of resistor 304.

The smoothed diode output signal 303 is fed to the input of a Schmitt inverter 306 to reduce the signal's susceptibility to noise. When the diode output signal decays below the Schmitt-input lower threshold (represented by dotted line 310), the Schmitt output signal 307 (equivalent to signal 116 in FIG. 1) changes and this output change corresponds to the start of an output pulse 308. At the end of the carrier gap 311, the capacitor 305 charges rapidly and when the Schmitt-input upper threshold (represented by dotted line 309) is passed, the Schmitt output signal will change and this second output change corresponds to the end of the output pulse 308.

An illustrative shallow demodulator will now be described with reference to FIGS. 4 to 10.

Referring now to FIG. 4, there is shown a typical AM or ASK modulated signal 400 that represents what would be seen at signal node 106 in FIG. 1 when a 10% modulated signal is received. As shown, when a 10% modulated signal is received, the amplitude of a modulated portion 406 will be 90% of the amplitude of the unmodulated signal 405, and this modulation depth is shown as 401. Signal 404 represents an output signal from demodulator 113, once the modulated signal 400 has been processed by the demodulator, and is equivalent to signal 115 in FIG. 1. Idealized modulation envelope signal 402 is shown following the changes in carrier amplitude.

FIG. 5a is a functional block diagram of the components of the shallow demodulator 113. As shown, the demodulator 113 comprises a peak detector 506, a sample and hold circuit 508 and a processor 510a. The peak detector and the sample and hold circuit 508 are operable to extract a modulation envelope signal 509 that is at least similar to (and preferably substantially the same as) the idealized modulation envelope signal 402 depicted in FIG. 4. The processor 510a (which may analogue circuitry, or a combination of analogue and digital circuitry) is configured to detect edge transitions between modulation levels and to output a digital signal, the demodulator output signal 404.

FIG. 5b is a functional block diagram of a particularly preferred embodiment of shallow demodulator in which the processor 510a has been replaced by an analogue to digital converter (ADC) 510 and digital signal processor (DSP) 512. In this instance, the peak detector 506 and the sample and hold circuit 508 extract a modulation envelope signal 509 that is at least similar to (and preferably substantially the same as) the idealized modulation envelope signal 402. Modulation envelope signal 509 is input to the ADC 510, and a digital modulation envelope signal 511 (which is a digital representation of the modulation envelope signal 509) is generated. This digital modulation envelope signal 511 is fed to the DSP 512, and the DSP 512 is configured to execute algorithms to detect the edge transitions between modulation levels and to output a digital signal, the demodulator output signal 404. In a particularly preferred arrangement the DSP is also provided with algorithms to perform a squelch function on small variations in the modulation envelope signal 509 and thereby inhibit the erroneous changes in the demodulator output signal 404 that would otherwise occur.

Preferably the ADC 510 should be capable of generating the digital modulation envelope signal as quickly as possible, and in a particularly preferred arrangement a multi-bit Delta Modulator ADC can be used to achieve the required conversion speed whilst reducing the integrated circuit area and power consumption.

Processing of the digital signals using DSP 512 can be achieved by the use of any processing method known by persons skilled in the art. Furthermore the DSP may comprise a microprocessor, a microcontroller, a state machine or the like. It is also the case that the functionality of DSP 512 may be provided by a processor within a linked or larger device. In the preferred embodiment it is advantageous to use a custom DSP to reduce the integrated circuit area.

In the preferred arrangement, the peak detector 506 is chosen to be able to rapidly track changes in carrier amplitude under difficult circumstances, such as when the modulation depth 401 (FIG. 4) may be as small as 30 mV and where the carrier amplitude 403 (FIG. 4) may be several volts and/or varying in amplitude.

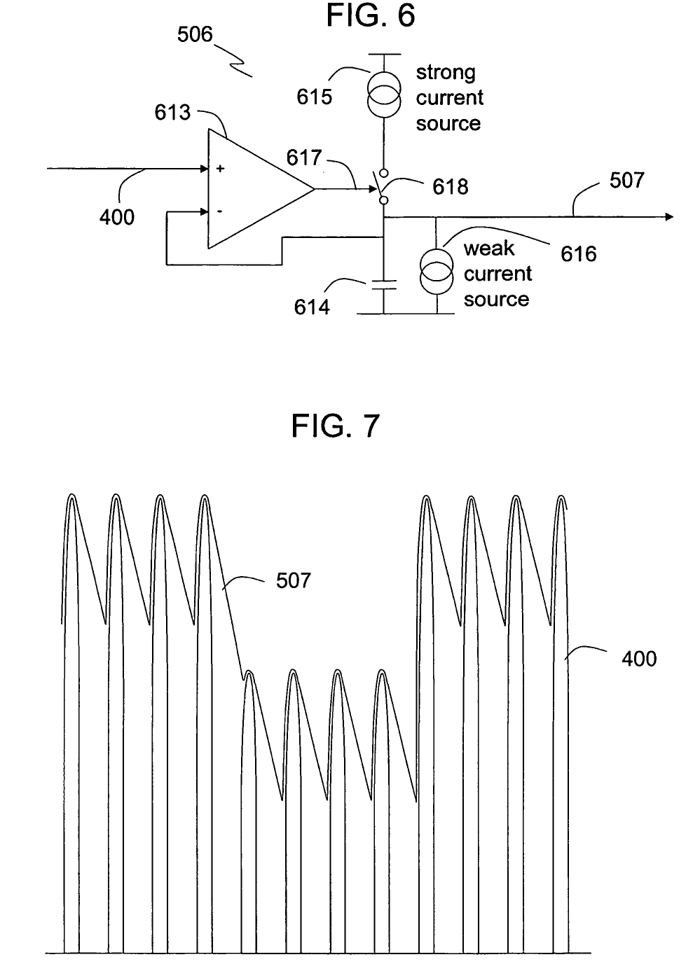

FIG. 6 is a schematic circuit diagram that illustrates the operating principal of the peak detector 506 (FIGS. 5a and 5b), and it will be understood by persons skilled in the art that variations to the circuit shown may be made whilst still achieving the same functionality. The circuit consists of a capacitor 614, and the voltage on the capacitor is the output signal, namely the peak detector signal 507. A comparator 613 is arranged to compare the modulated carrier signal 400 to the peak detector signal 507, and a capacitor-charging source 615 (which comprises a strong current source) is switched onto the capacitor by the comparator 613 and a switch 618. In the preferred arrangement, the capacitor 614 is charged rapidly when the modulated carrier signal 400 is greater than the output 507, and is discharged slowly when the modulated carrier signal is less than the output. In particular, when the modulated carrier signal 400 falls below the level of the peak detector signal 507, the comparator 613 causes switching means 618 to open and capacitor 614 is discharged slowly by a weak current source 616 arranged across it.

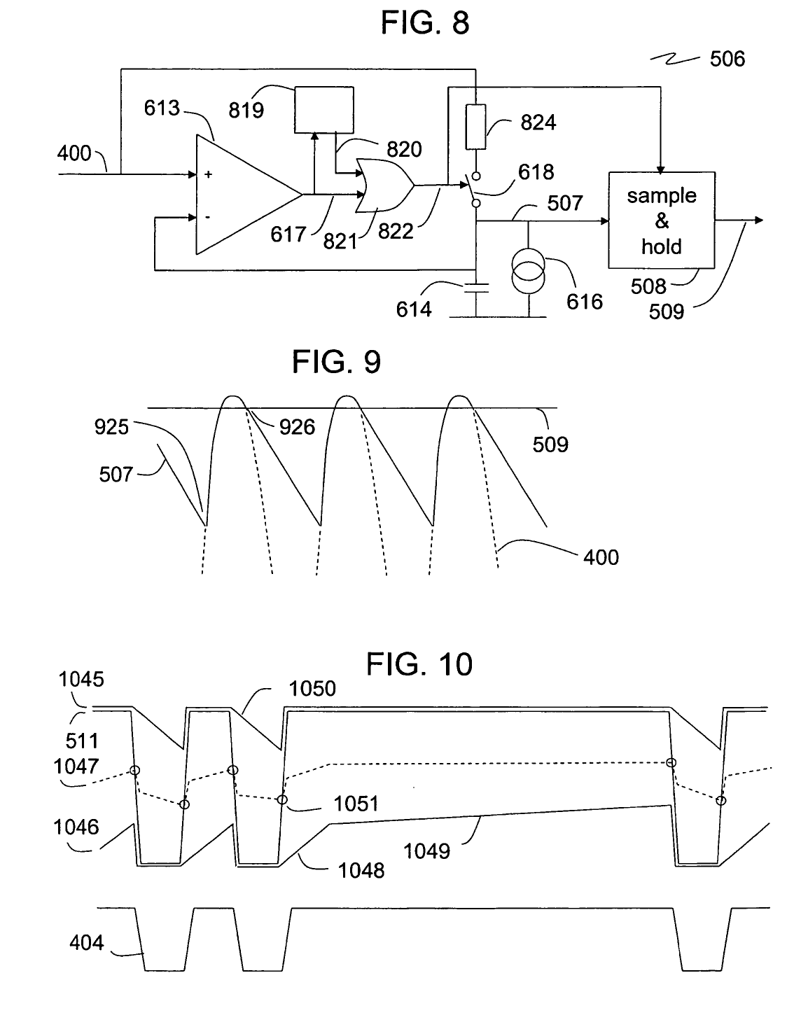

FIG. 7 is a schematic representation of the peak detector signal 507 and the modulated carrier signal 400, which are the output and input signals respectively, from and to the circuit of FIG. 6. The desired modulation envelope signal 509 (from FIG. 8) is obtained from the peak detector signal 507 by the use of a sample and hold circuit 508 (FIG. 8). As will be appreciated from FIG. 7, the modulation envelope signal 509 is similar to the idealized modulation envelope signal 402, the main difference being that transitions between level changes are not as fast as the transitions shown as vertical lines in the signal 400, that is to say the transitions are not as quick as those in the received signal.

A timer circuit may also be included that provides additional control of capacitor 614 charging and of the sample and hold circuit 508 (FIG. 8).

Referring now to FIG. 8, there is shown a preferred embodiment of peak detector 506 that addresses this potential problem. In particular, in this embodiment a signal 822 that controls operation of the switch 618 is also used to control operation of the sample and hold means 508. The signal 822 is provided via an OR-gate 821 from either comparator 613 or a timer circuit 819 that is arranged to reset when comparator 613 provides an output signal. The timer circuit 819 is configured to provide a time-out output signal 820 at a predetermined time after being reset by comparator output signal 617, and this predetermined time is preferably set to be equal to more than one carrier cycle time. If comparator 613 provides an output signal 617 at every carrier interval time, then timer means 819 will not output a signal. However if comparator 613 fails to output a signal 617 for more than the time set as the time-out of the timer circuit 819 then the output signal 820 will force operation of the switch 618 and the sample and hold circuit 508, and in so doing will set the modulation envelope signal 509 to be at a level corresponding to the modulated carrier signal 400.

Such timer circuits are well known to persons of ordinary skill in the art. For example, the timer circuit could comprise monostable or clocked flip-flops, for example. In a similar manner, whilst the switch 618 can be any one of a number of possible devices, in a particularly preferred embodiment the switch is a field effect transistor (FET).

In the preferred embodiment of FIG. 8, weak current source 616 performs the function of discharging the capacitor 614, however a high-value resistor could be used as an alternative to this weak current source 616. Similarly, the resistance of the switch 618 is represented by a resistor 824, which performs the function of the strong current source 615 shown in FIG. 6.

FIG. 9 is a schematic representation of an input signal 507 to the sample and hold circuit 508, and an output signal 509 from the sample and hold circuit 508. As mentioned previously, the signal 822 from peak detector 506 (FIG. 5a or 5b) controls the sample and hold circuit 508 (the manner of such control being well known to persons skilled in the art). In operation of the preferred embodiment at time position 925 on or near each peak, the sample and hold circuit 508 starts to store the peak voltage, and then at time position 926 the sample and hold circuit transfers the newly stored voltage to the held voltage, and this held voltage provides the output signal 509.

FIG. 10 is a schematic representation of signals within the digital signal processing means 512 (FIG. 5b), that preferably comprises a DSP. Signals 511, 1045, 1046 & 1047 are shown as analogue signals in FIG. 10 for clarity whereas it will be appreciated that in actual fact that are PCM digital signals.

In operation, algorithms within the DSP 512 operate on an input signal 511 to produce a negative-peak signal 1046 by initially storing minimum values and then when the input signal 511 increases, incrementing the negative-peak signal at a predetermined rate 1048 (a relatively fast rate) for a predetermined period, after which the increment rate is reduced 1049 (to a relatively slow rate). The predetermined rate and predetermined period may be set or programmable and the level of each depends on the end application, antenna used, data rate and gap length within the received signal.

The negative-peak signal 1046 is incremented in this way so as to follow slow average changes in level of the input signal 511. In particular, the fast increment rate 1048 of the negative-peak signal 1046 counters effects of short-duration glitches, such as noise spikes, on the input signal 511.

A positive-peak signal 1045 is also derived from the input signal 511 at the same time and in a similar manner to the way in which the negative-peak signal 1046 is derived. The positive-peak signal 1045 also has two decrement rates, the fast decrement rate 1050 of which is shown in FIG. 10.

The positive-peak and negative-peak signals 1045, 1047 are used to generate an average signal 1047, and algorithms within the DSP 512 operate so that when the input signal 511 crosses the average signal 1047, highlighted in FIG. 10 by circles 1051, the state of the demodulator output signal 404 (FIG. 5b) is changed.

In a preferred modification of this embodiment, the DSP algorithms may additionally perform a squelch function to inhibit changes in the demodulator output signal 404 when the input signal 511 is of such a small level that erroneous output data would otherwise result, or when other conditions are known to exist that would otherwise produce erroneous changes. Additional standard signal processing techniques such as filtering may also be used where required to enhance demodulator performance.

As an alternative to the shallow demodulator described above, an I&Q demodulator could instead be used. The I&Q demodulator effectively mixes the incoming signal with a signal or multiple signals of the same frequency (I and Q) and then processes the mixed signal to extract the modulation. The advantage of an IQ demodulator is that it can be used to demodulate both phase modulation and amplitude modulation at a depth of 10%. Optionally, the deep demodulator described above could be operative with the shallow demodulator to track the incoming shallow signal. This is advantageous if the symbol rate of the incoming signal approaches or exceeds the maximum symbol rate that can be handled by the ADC 510, resulting in unknown delays in the ADC which introduce errors in the recovered signal For such an arrangement the deep demodulator is capable of demodulating the shallow modulated signal to an extent sufficient to track the incoming signal.

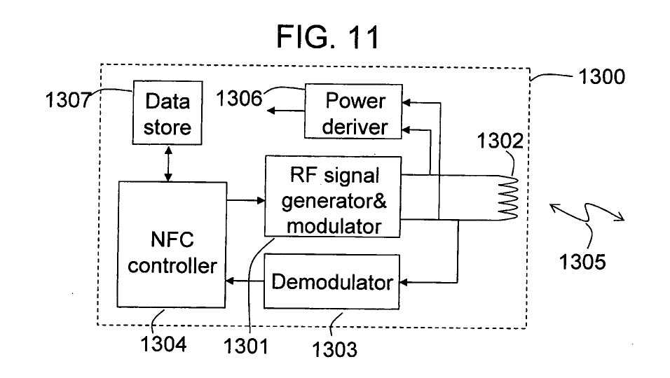

FIG. 11 is a schematic block diagram of an illustrative NFC device 1300. As previously mentioned an NFC device can operate in two modes, as either a reader or a tag, referred to herein as ‘reader-mode’ and ‘tag-mode’ respectively. In this example, when operating in reader-mode, RF signal generator and modulator 1301 generates an RF signals which is fed to antenna 1302, which causes a magnetic field 1305 to be generated in the vicinity of the NFC device 1300. The controller 1304 is connected to the RF signal generator and modulator 1301 and a demodulator 1303 and may be responsible for controlling the RF signal generator and modulator 1301 to modulate the generated RF signal or magnetic field 1305. The controller 1304 may be a RISC processor, state machine, microcontroller or microprocessor and may additionally be connected to a data store 1307 comprising a suitable form of volatile and/or non-volatile memory (for example EEPROM).

In this example, when operating in ‘tag-mode’, a magnetic field will be received at antenna 1302 and, where modulated, demodulator 1303 will demodulate the received magnetic field and provide the demodulated signal to the controller 1304. The controller 1304 may as a result of receipt of the demodulated signal cause data to be written to data store 1305 or data to be read from the data store and transmitted though modulation of the received magnetic field. The NFC device may also comprise a power deriver 1306 responsible for derivation of a power supply from the received magnetic field.

In NFC devices of the present invention the demodulator 1303 will comprise both a shallow and deep demodulator and a detector for detecting the type of modulation received and as a result providing a demodulated signal to the NFC controller 1304. The shallow and deep demodulator and detector may be of the forms described in more detail above.

The demodulators may both operate simultaneously to receive an RF signal, and following determination of the depth of modulation the controller may cease operation of one or other of the demodulators in dependence the detected modulation depth. Optionally, the NFC device may be configured such that only one of the demodulators is operative to demodulate a received RF signal and depending on the determination of the depth of modulation the controller may continue operation of that demodulator, may also activate the other demodulator or cease its operation activate the other demodulator in dependence the detected modulation depth.

For particular applications, NFC devices can be controlled to operate as either an initiator (reader-mode) or a target (tag-mode).

An NFC device may be set up to operate in either initiator-mode or target mode by default, and a change in mode of operation may be due to the operation of a larger device, receipt of an externally generated RF signal by the NFC device or as a result of some instruction received from within the NFC device or larger device. In a particularly preferred arrangement the NFC device is set to default to operation in tag-mode as this has the advantage of saving power within the device or larger device in which the NFC device is incorporated.

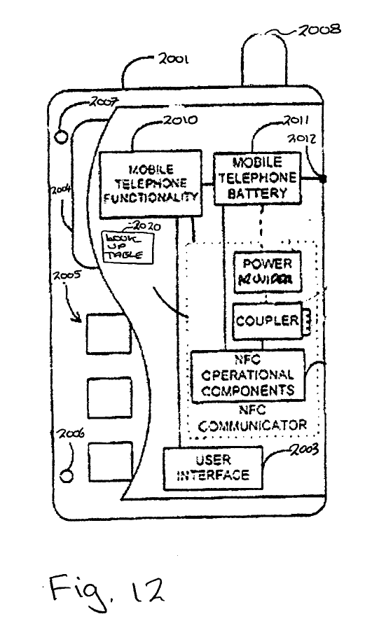

A further embodiment is shown schematically in FIG. 12 and relates to an NFC communications enabled apparatus in the form of a cellphone (mobile telephone) 2001. The mobile telephone 2001 has the usual features of a mobile telephone including mobile telephone functionality 2010 (in the form of, usually, a programmed controller, generally a processor or microprocessor with associated memory or data storage, for controlling operation of the mobile telephone in combination with a SIM card), an antenna 2008 for enabling connection to a mobile telecommunications network, and a user interface 2003 with a display 2004, a keypad 2005, a microphone 2006 for receiving user voice input and a loudspeaker 2007 for outputting received audio to the user. The mobile telephone also has a chargeable battery 2011 coupled to a charging socket 2012 via which a mains adapter (not shown) may be connected to enable charging of the battery 2011. The mobile telephone 2001 may have an alternative or additional power supply (not shown), for example a reserve battery or emergency battery.

As is well known in the art, the cellphone interfaces and interacts with the network of the particular country or geographic region of the world in which it is located and as a result of that interaction can determine the identity of the country or region in which the network with which it is interface is located, that is to say its geographic location.

In this embodiment, the cellphone 2001 includes in memory, for example in ROM or RAM, or can access remotely (via the cellular telecommunications network to which the phone can connect) a look-up table (indicated generally as 2020 in FIG. 12) specifying which NFC device signal protocol/s, in particular signal modulation depth/s, are in use in particular countries (for example Type A or Type B). The mobile telephone utilizes the information identifying the country in which the phone is currently located and inspects the aforementioned look-up table to determine which modulation protocols or depths are in use in the country in which the phone is located. Once this information has been retrieved the phone controller can interface with the NFC device to temporarily turn off all those signal demodulators and modulators that are not useful for the particular modulation protocols or depths in use in the country or region in which the phone is currently located. Turning off these components reduces the power drawn by the NFC circuitry and hence helps increase the battery life of the mobile telephone.

It will be apparent from the foregoing that several different embodiments of NFC devices are possible and the devices described are given by way of illustration only. It will further be understood, and should be noted, that modifications, substitutions and additions may be made to the particular embodiments described without departing from the spirit and scope of the invention.

For example, it will be immediately apparent to persons skilled in the art that the deep-demodulator 112 and shallow-demodulator 113 (FIG. 1) can be employed to detect modulation levels different than the 100% and 10% described above. It will also be apparent to those skilled persons that in circumstances where more than two modulation methods might be received, the embodiments described may be adapted to include more than two demodulators.

A final point of note is that whilst certain combinations of features have been identified in the accompanying claims, the scope of the present invention is not limited to those combinations and instead extends to encompass any combination of features herein described irrespective of whether or not that particular combination has been explicitly enumerated in the accompanying claims.

I claim:

1. An NFC device comprising a modulation-depth detector operable to detect a plurality of different modulation depths, said detector responsive to receipt of a signal by said NFC device to generate a depth signal for transmission to a controller for said NFC device indicative of the modulation depth of said received signal.

2. An NFC device according to claim 1, wherein said controller is configured to select for demodulation of subsequent signals received by said NFC system a demodulator that is capable of demodulating signals of the modulation depth detected by said detector responsive to receipt of said depth signal from said detector.

3. An NFC device according to claim 1, wherein said controller forms part of the NFC device.

4. An NFC device according to claim 1, comprising a plurality of demodulators each configured to demodulate received signals of a particular modulation depth and generate a demodulated output signal.

5. An NFC device according to claim 4, wherein said detector is arranged to receive the demodulated output signals from said demodulators and compare respective received demodulated signals with associated reference signals, and output a match signal indicating which of said received signals at least substantially matches the reference signal with which it has been compared.

6. An NFC device according to claim 1, wherein said detector comprises a first data recogniser configured to detect a first modulation depth, and a second data recogniser configured to detect a second modulation depth different from said first depth.

7. An NFC device according to claim 1, wherein said first modulation depth is a deep modulation depth and said second modulation depth is a shallow modulation depth.

8. An NFC device according to claim 6, wherein said first modulation depth is substantially 100%, and said second modulation depth is substantially 10%.

9. An NFC device according to claim 1, wherein said received signal is modulated by one or more modulation types selected from a group consisting of: load modulation and amplitude modulation.

10. An NFC device according to claim 6, wherein at least one data recogniser comprises a peak detector, a sample and hold circuit, and a processor.

11. An NFC device according to claim 1 wherein said system is configured at least in part as an integrated circuit.

12. A modulation-depth detector for use in an NFC device, the detector comprising a data recogniser configured to receive a plurality of demodulated signals each of which have been derived from a single received signal of unknown modulation depth and a plurality of associated reference signals, said data recogniser being operable to compare said received demodulated signals with respective reference signals and output a match signal indicating which of said received demodulated signals at least substantially matches the reference signal with which it has been compared.

13. A detector according to claim 12, wherein said demodulated signals are generated by demodulating said single received signal of unknown modulation depth with a plurality of demodulators that are each configured to demodulate signals having a particular modulation depth.

14. An NFC device comprising a plurality of demodulators wherein each demodulator is configured to demodulate signals of respective modulation depth.

15. An NFC device according to claim 14, wherein at least one of said plurality of demodulators is capable of demodulating a signal having a modulation depth other than the modulation depth for which it is configured.

16. An NFC device according to claim 14, wherein at least one of said demodulators is an IQ demodulator.

17. An NFC device according to claim 14, wherein said plurality of demodulators comprises two demodulators respectively configured to demodulate signals of shallow and deep modulation depth, and wherein said shallow demodulator is operative to demodulate in part at least a signal having deep modulation.

18. An NFC device according to claim 17, wherein said deep modulation depth is substantially 100%, and said shallow modulation depth is substantially 10%.

19. A host apparatus comprising an NFC device according to claim 1, wherein said controller forms a part of said host apparatus or said controller interfaces to said host apparatus functionality.

20. A host apparatus according to claim 19, wherein said host apparatus is selected from the group consisting of a mobile or cellular telephone, a portable digital assistant, an IPOD®, a portable music player, a vending machine and a portable computer.

21. A host apparatus comprising an NFC device according to claim 14, said host apparatus comprising a mobile or cellular telephone configured to determine a geographic location in which it is operating and operative to select a one of said plurality of demodulators corresponding to the modulation depth used for NFC communications in said geographic location.

22. A method of operating an NFC device, the method comprising:
providing a controller; a plurality of demodulators each of which is configured to demodulate received signals of a different modulation depth and outputting a demodulated signal; and a detector arranged to receive the demodulated signals from said demodulators and a plurality of reference signals, compare respective received demodulated signals with associated reference signals, and output a match signal indicating which of said received signals at least substantially matches the reference signal with which it has been compared;
receiving a signal of unknown modulation type to initiate a communications session;
demodulating said unknown signal using said plurality of demodulators to generate a plurality of demodulated signals;
comparing said plurality of demodulated signals with their associated reference signals;
outputting to said controller a signal indicating which of said demodulators has generated a demodulated signal that at least substantially matches the associated reference signal, and
controlling the system to demodulate received signals for a remainder of said session using only that demodulator which has been indicated by said detector as generating a signal which at least substantially matches the associated reference signal.
